(19) United States
(12) Patent Application Publication
(10) Pub. No.: US 2012/0158425 A1
(43) Pub. Date: Jun. 21, 2012

(54) Pharmacy Workflow Process

(76) Inventors: Thomas P. Rhoads, JR., Raleigh, NC (US); Keith E. Overfield, Raleigh, NC (US)

(21) Appl. No.: 13/325,782

(22) Filed: Dec. 14, 2011

Related U.S. Application Data
(60) Provisional application No. 61/424,164, filed on Dec. 17, 2010.

(51) Int. Cl. G06Q 50/22

(52) U.S. Cl. 705/2

(57) ABSTRACT

A method of verifying a prescription (Rx) dispensed by a pharmacy includes the steps of: (a) entering host computer Rx identifying information about a prescription into a pharmacy host computer; (b) fulfilling the prescription with an automated pharmaceutical dispensing machine; (c) entering Rx identifying indicia for the prescription into an automated will call system; (d) automatically correlating the Rx identifying indicia for the prescription to the host computer Rx identifying information for the prescription; (e) responsive to a retrieval request, inquiring whether the prescription is verified via steps (b), (c) and (d); and (f) providing the verified prescription to a retriever of the prescription. This process can enable a prescription to be verified automatically, thereby saving the pharmacist time and labor.

### RELATED APPLICATION

This application claims the benefit of and priority from U.S. Provisional Patent Application Ser. No. 61/424,164, filed Dec. 17, 2010, the disclosure of which is hereby incorporated herein in its entirety.

### FIELD OF THE INVENTION

The present invention is directed generally to pharmacy, and more particularly to verification of pharmaceutical prescriptions.

### BACKGROUND OF THE INVENTION

There is an ongoing and predicted long-term shortage of licensed pharmacists. Due to the increasing age of the population and the ever-increasing number of prescription medicines available, the demand for prescription drugs is growing at rate that will far exceed the capacity and numbers of licensed pharmacists. The net impact of this imbalance is that pharmacists are increasingly spending more time doing clerical and administrative tasks such as verifying filled prescriptions and checking data entry done by pharmacy technicians. Since the capacity of any one pharmacist is fixed, the output of a pharmacy has become constrained. Consequently, the labor and total cost per prescription continues to rise. The December 2000 Department of Health and Human Services Report to Congress titled “The Pharmacist Workforce: A Study of the Supply and Demand for Pharmacists”, which is hereby incorporated by reference into the present application, provides an overview of the above problem.

As part of the drug verification process, many existing pharmacy filling systems and procedures still require a human operator, whether that operator is a technician or a licensed pharmacist, to validate visually whether the drug that is delivered to the customer is correct. Existing visual verification techniques typically rely on comparing an electronic image of the prescribed medication, i.e., a picture of the prescribed medication retrieved from a data library, with the actual medication that is dispensed for the patient. Other systems and procedures rely on comparing the dispensed medication with that in the original manufacturer's supply container, or comparing an electronic image of the filled prescription with an electronic image of the prescribed medication retrieved from a data library.

It is typically deemed preferable for pharmacists to spend a greater amount of time performing tasks such as counseling patients. Therefore, it is desirable to reduce the amount of time spent by the pharmacist performing many of the tasks described above. In particular, the verification step can consume a great deal of the pharmacist's time and, since approximately 15% of prescriptions are never picked up from the pharmacy, a significant portion of the pharmacist's time may be wasted verifying prescriptions that never get to the patient.

### SUMMARY OF THE INVENTION

As a first aspect, embodiments of the invention are directed to a method of verifying a prescription (Rx) dispensed by a pharmacy. The method comprises the steps of: (a) entering host computer Rx identifying information about a prescription into a pharmacy host computer; (b) fulfilling the prescription with an automated pharmaceutical dispensing machine; (c) entering Rx identifying indicia for the prescription into an automated will call system; (d) automatically correlating the Rx identifying indicia for the prescription to the host computer Rx identifying information for the prescription; (e) responsive to a retrieval request, inquiring whether the prescription is verified via steps (b), (c) and (d); and (f) providing the verified prescription to a retriever of the prescription. This process can enable a prescription to be verified automatically, thereby saving the pharmacist time and labor.

As a second aspect, embodiments of the invention are directed to a method of verifying a prescription (Rx) dispensed by a pharmacy, comprising the steps of: (a) entering host computer Rx identifying information about a prescription into a pharmacy host computer; (b) fulfilling the prescription with an automated pharmaceutical dispensing machine, wherein the automated pharmaceutical dispensing machine includes a security feature that assures accurate replenishment of pharmaceuticals into the machine; (c) entering Rx identifying indicia for the prescription into an automated will call system; (d) automatically correlating the Rx identifying indicia for the prescription to the host computer Rx identifying information for the prescription to confirm that the pharmaceutical in the prescription matches the pharmaceutical prescribed; (e) responsive to a retrieval request, inquiring whether the prescription is verified via steps (b), (c) and (d); and (f) providing the verified prescription to a retriever of the prescription.

As a third aspect, embodiments of the invention are directed to a method of verifying a prescription (Rx) dispensed by a pharmacy, comprising the steps of: (a) entering host computer Rx identifying information about a prescription prescribing a pharmaceutical into a pharmacy host computer; (b) dispensing the prescribed pharmaceutical into a container with an automated pharmaceutical dispensing machine, wherein the automated pharmaceutical dispensing machine includes a security feature that assures accurate replenishment of pharmaceuticals into the machine; (c) scanning a label on the container to enter Rx identifying indicia for the prescription into an automated will call system; (d) automatically correlating the Rx identifying indicia for the prescription to the host computer Rx identifying information for the prescription to verify that the pharmaceutical prescribed in the host computer Rx identifying information matches the pharmaceutical identified on the container label; (e) responsive to a retrieval request, inquiring whether the prescription is verified via steps (b), (c) and (d); and (f) providing the verified prescription to a retriever of the prescription.

### BRIEF DESCRIPTION OF THE FIGURES

FIG. 1 is a flow chart depicting prior art pharmacy operations.

FIG. 2 is a flow chart depicting pharmacy operations according to embodiments of the present invention.

### DETAILED DESCRIPTION OF EMBODIMENTS OF THE INVENTION

The present invention will now be described more fully hereinafter, in which preferred embodiments of the invention are shown. This invention may, however, be embodied in different forms and should not be construed as limited to the embodiments set forth herein. Rather, these embodiments are provided so that this disclosure will be thorough and complete, and will fully convey the scope of the invention to those skilled in the art. In the drawings, like numbers refer to like elements throughout. Thicknesses and dimensions of some components may be exaggerated for clarity.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein the expression “and/or” includes any and all combinations of one or more of the associated listed items.

In addition, spatially relative terms, such as “under”, “below”, “lower”, “over”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly. Well-known functions or constructions may not be described in detail for brevity and/or clarity.

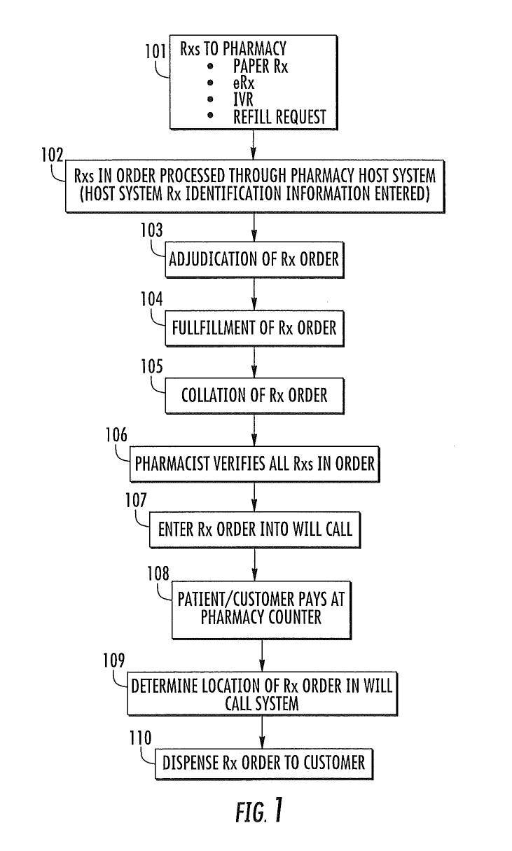

The workflow process for a typical pharmacy is shown in the flow chart of FIG. 1. At block 101, a prescription (Rx) is presented at a pharmacy. This can occur in one of several ways, such as via a paper Rx, an electronic Rx (eRx) directly from the physician, or telephonically through an interactive voice response (IVR) system. Additionally, a patient with a request for refill of a current prescription may simply call in and speak to or leave a message for pharmacy staff, make a refill request in person in the pharmacy, or, perhaps, place a refill order over the Internet. In some cases, there may be more than one Rx ordered for a particular patient; a Rx order may consist of more than one Rx and will be used here, interchangeably with “Rx”, to mean one or more than one Rx for a particular patient.

In any of the above instances, the Rx request is entered into the pharmacy host computer system (block 102). As used herein, “host computer Rx identification information” means information entered into and stored by the host computer, such as patient name, address, doctor name, drug name, drug dosage, date, insurance information, and the like. The pharmacy host computer may be a single device, part of a network, or other known computer architecture employed by pharmacies.

Once all of the “host computer Rx identification information” is entered into the host system, adjudication of the Rx, where the insurer is asked to review and approve filling of the Rx, is performed at block 103. Following a positive adjudication, the Rx order is fulfilled (block 104). Fulfillment of the prescription can occur in several ways. The Rx, or one or more components of the Rx order, may be filled by an automated system at the pharmacy such as that disclosed in U.S. Pat. No. 7,118,006 or an updated version such as that disclosed in U.S. patent application Ser. No. 12/492,933, the disclosures of which are hereby incorporated herein in their entirety. The Rx, or one or more components of the Rx order, may be filled using a semi-automated system such as, for example, that disclosed in U.S. Pat. No. 7,077,286 or U.S. patent application Ser. No. 12/191,571, the disclosures of which are hereby incorporated herein in their entirety. The Rx, or one or more components of the Rx order, may be filled manually, in which case the pharmacy staff member would locate and remove the appropriate stock bottle from a shelf or other location in the pharmacy, and remove the required number of tablets for the prescription. The tablets may be counted by the pharmacist, or may be counted using equipment designed for counting of pharmaceuticals. Examples of this type of equipment are scales utilizing drug weight data for counting such as the ACCUCOUNT® pharmacy scale available from Parata Systems, LLC (Durham, N.C.), DRX300s, DRX500s and other models available from Fulcrum, Inc. (Clifton, N.J.), or automatic counters such as the KL15e, KL15df or others sold by Kirby Lester, LLC (Lake Forest, Ill.). It is also possible that the Rx, or one or more components of the Rx order, may be filled by retrieval of a product, rather than the dispensing of pills, such as an inhaler, tube of ointment, ampule, bottle of powder, oral contraceptives, etc. or a prepacked vial (for those pharmaceuticals that are dispensed regularly in particular amounts, pills may be counted and placed in a vial or other package prior to receipt of a particular order for that pharmaceutical, and the vial or package then stored on the pharmacy shelf until needed to fill a Rx).

Once all Rxs in the order have been filled, the order is collated at block 105, such that all components of the order are collected and individual filled Rxs of one Rx order are located together. Individual Rxs within an Rx order may be filled in different ways, as discussed above, and/or components of the Rx order may be retrieved from different locations in the pharmacy, thus requiring collation.

At block 106, verification of the Rx order is performed. The verification process is typically performed by a pharmacist and includes two aspects of verification. The first part of the verification is confirmation that the correct drug has been dispensed; that is, the drug that is contained in each vial, box, package, etc. is indeed the drug that is designated by machine readable indicia on the label (i.e., bar code, RFID tag, etc.) or human readable indicia on the label (such as drug name and dosage and/or NDC number) as being in that vial, box, package, etc. The second part of the verification process is confirmation, for each Rx in the Rx order, that the drug that is in the vial, box, package, etc. and labeled for a specific patient is the correct drug for the correct patient dictated by the Rx that was received at the pharmacy (in block 101). These verification steps are typically performed manually, requiring the pharmacist to remove the cap from the vial to view the contents of the vial (often removing some of the contents so that they can be readily viewed), read the vial label, review the Rx received from the physician and replace the cap on the vial. In some cases, the system may provide an image of the contents of the vial for the pharmacist to use for verification.

The verified Rx or Rx order may then be placed in a will call system (block 107) to await pick up. In association with payment for the Rx order (block 108), the location of the Rx order in the will call system is determined (block 109) and the Rx order is retrieved and dispensed to the patient/customer at block 110 (the person picking up the Rx order at the pharmacy may be the patient or may be another customer picking up the Rx order on behalf of the patient).

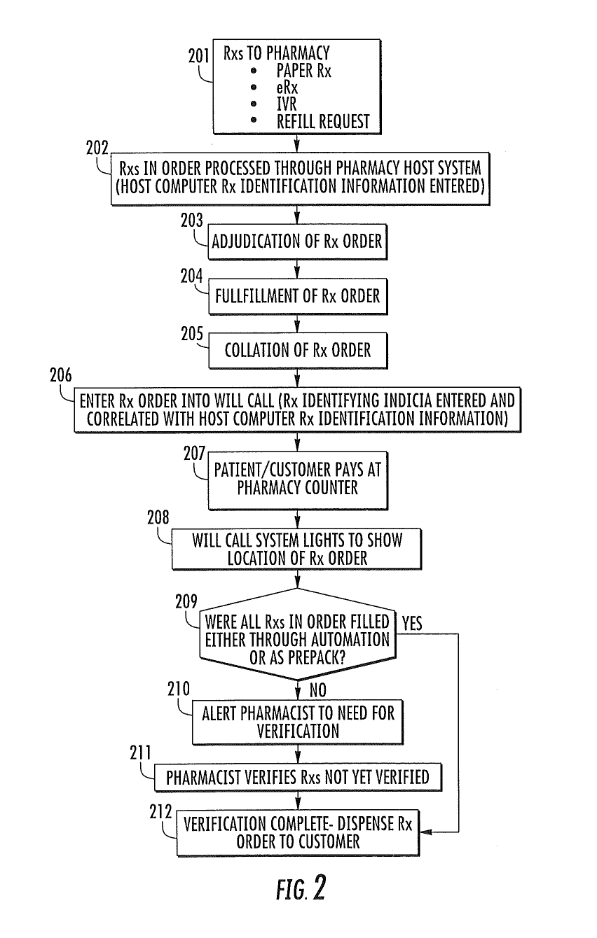

To improve the pharmacist's efficiency, a new workflow scheme has been developed and is shown in the flow chart of FIG. 2. In this scheme, the first three steps in the process are unchanged: a Rx is presented at the pharmacy at block 201, the host computer Rx information is entered into the pharmacy host system at block 202, and adjudication is performed at block 203.

The fourth step of the process is, in essence, unchanged, in that this step (block 204) still includes fulfillment of the Rx order. However, aspects of this step now provide for automatic verification of some Rxs. For example, some automation systems in pharmacies may include locking cells, such as those described in U.S. Pat. No. 7,840,307 (“the '307 patent”), the disclosure of which is hereby incorporated herein in its entirety. The cells are the bins of the automated dispensing system which hold the pharmaceuticals and from which the pharmaceuticals are dispensed. As described in the '307 patent, locking cells include a lock on the door that is used for replenishment of the inventory in the bin; the lock is typically in the latched position during normal operation of the system and when the system is not in use, thereby preventing access to the inside of the bin. In order to replenish the contents of the locking cell, the pharmacy worker must follows steps to ensure the correct drug is being added to the cell, which may include using a scanner to scan an identifier that identifies the contents of the bin. Such an identifier may be located on or near the bin and may be any type of machine readable indicia, such as a bar code or RFID tag, which includes identifying information for the contents of the bin. A scanner is then used to scan an identifier on a refill bottle or the like (which contains potential contents of the bin) that identifies the contents of the refill bottle. The identifier on the refill bottle may be any type of machine readable indicia such as a bar code or RFID tag. The controller of the automated dispensing system then compares the identities of the contents of the bin and the potential contents from the refill bottle. If the controller determines that the identities do not match, then the lock to the door is not released and the door cannot be opened. If the controller determines a positive comparison between the identifiers, then the controller sends a signal that results in the release of the locking mechanism and unlocking of the door. The door can then be opened to provide access to the inside of the bin for replenishing. Once replenishment is complete, the door is closed and the locking mechanism is again engaged to prevent access to the bin.

Because such security checks are required to confirm that the correct pharmaceutical is being added to the bin prior to replenishment, no further access to the inside of the bin is permitted following replenishment, and an automated system performs the dispensing of the product, the verification that the correct drug was dispensed into the vial can be considered complete at this step.

At block 205, individual components of the Rx order are collated and at block 206 the Rx order is entered into an automated will call system such as, for example, that described in U.S. Pat. No. 7,410,098, the disclosure of which is hereby incorporated herein in its entirety. The automated will call system includes a controller which provides the command and control functions for the will call system, and manages and tracks the movement of items within the system. The controller may be a standalone device, such as a PC, or may be embedded within the system, such as at a user workstation or within the storage unit. The controller includes a memory to store all received information from outside the system, as well as the locations of all stored items and length of time each item has been in the system. When Rx orders are entered into the automated will call system, identifying indicia for the Rx are entered into the system either manually (i.e., by pharmacy personnel via a touch screen or keyboard) or by scanning of one or more bar codes or other machine readable indicia (such as an RFID tag) on the Rx order. This “Rx identifying indicia” may include, but are not limited to, patient name, patient address, patient phone number, patient identification number, prescription number, order number, name of the prescribed pharmaceutical, or dosage of the prescribed pharmaceutical. The Rx identifying indicia are correlated, by the will call system controller, with other pertinent information such as the host computer Rx identification information received from the pharmacy host system. As noted above, host computer Rx identification information may include, but is not limited to, order number, patient name, patient address, patient phone number, time, date, prescription number, patient identification number, national drug code (NDC) number for the prescribed medication, storage requirements, control level of the drug, or the like. Thus, in embodiments of the invention, this correlation is the second portion of the verification process discussed above, providing confirmation that the correct pharmaceutical has been dispensed to fulfill the Rx order for the correct patient. Additionally, any components of the Rx order that are prepacks or unit-of-use, as described above, are also verified at this point. When the controller of the automated will call system makes the comparison of the Rx identifying indicia on the Rx order package with the host computer Rx identification information for the Rx order, comparing information such as the patient name, the name of the prescribed pharmaceutical and the dosage of the prescribed pharmaceutical, the controller can verify that there is a match between these pieces of information. For those Rxs filled using an automated dispensing system with locking cells or prepacks/unit-of-use, as described above, the verification process is now complete without any time spent on the process by the pharmacist.

Upon receipt of a signal at the controller that an article (Rx or Rx order) has been inserted into a location of the automated will call system, the controller stores the location of the inserted article in the memory. When a customer arrives at the pharmacy to pick up and/or pay for a Rx or Rx order (block 207), the pick-up process is initiated by entering Rx retrieval information to identify the patient or the Rx/Rx order to be retrieved, “Rx retrieval information” may include the patient name, patient identification number, prescription number or the like and may be entered by the pharmacy staff or the customer using a keyboard, touch screen, scanner, card reader or other appropriate device. Once the Rx or Rx order has been selected for retrieval from the will call system, the controller retrieves the designated location of the selected R×(s) from the memory and activates a work flow coordinator. Upon activation of the work flow coordinator, at least one light on the designated storage unit illuminates (block 208), if more than one storage unit is available in the pharmacy, guiding pharmacy personnel to that storage unit (the storage unit may additionally or alternatively include a refrigerated unit for storage of Rx items requiring refrigeration). A light in or near the opening of the storage unit also illuminates (may be the same or a second light) prompting pharmacy personnel to remove the R×(s) from the designated storage location. If there are components of the Rx order that have not completed verification at this point (i.e., dispensed pharmaceuticals counted manually) (decision 209), the Rx order is flagged to alert the pharmacist of the requirement to verify least a portion of that Rx order (block 210). The flag can be a flashing light, light of a particular color (such as red), audible alert, notification on the computer monitor, etc. The pharmacist performs the steps of the traditional verification process for any such Rxs in that order (block 211) and the order is then delivered to the waiting customer (block 212).

Since as much as 80% of a pharmacy's oral solid medications may be handled in an automated system of this type and since this improved work flow process releases the pharmacist from verifying prescriptions that are never picked up, this new process can result in significant time savings for pharmacists.

The foregoing is illustrative of the present invention and is not to be construed as limiting thereof. Although exemplary embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention.

That which is claimed is:

1. A method of verifying a prescription (Rx) dispensed by a pharmacy, comprising the steps of:
(a) entering host computer Rx identifying information about a prescription into a pharmacy host computer;
(b) fulfilling the prescription with an automated pharmaceutical dispensing machine;
(c) entering Rx identifying indicia for the prescription into an automated will call system;
(d) automatically correlating the Rx identifying indicia for the prescription to the host computer Rx identifying information for the prescription;
(e) responsive to a retrieval request, inquiring whether the prescription is verified via steps (b), (c) and (d); and
(f) providing the verified prescription to a retriever of the prescription.

2. The method defined in claim 1, wherein the prescription is part of a prescription order that includes a plurality of prescriptions.

3. The method defined in claim 2, further comprising the step of collating the plurality of prescriptions prior to step (c).

4. The method defined in claim 1, further comprising the step of adjudicating the prescription.

5. The method defined in claim 1, wherein, if the inquiry in step (e) is negative, further comprising the step of manually verifying the prescription.

6. The method defined in claim 1, wherein the automated pharmaceutical dispensing system includes a plurality of bins, each containing a bulk supply of a pharmaceutical, and wherein each of the bins includes a security door, and wherein replenishment of one of the bins requires confirmation regarding the identity of a replenishing pharmaceutical in order to open the security door.

7. A method of verifying a prescription (Rx) dispensed by a pharmacy, comprising the steps of:
(a) entering host computer Rx identifying information about a prescription into a pharmacy host computer;
(b) fulfilling the prescription with an automated pharmaceutical dispensing machine, wherein the automated pharmaceutical dispensing machine includes a security feature that assures accurate replenishment of pharmaceuticals into the machine;
(c) entering Rx identifying indicia for the prescription into an automated will call system;
(d) automatically correlating the Rx identifying indicia for the prescription to the host computer Rx identifying information for the prescription to confirm that the pharmaceutical in the prescription matches the pharmaceutical prescribed;
(e) responsive to a retrieval request, inquiring whether the prescription is verified via steps (b), (c) and (d); and
(f) providing the verified prescription to a retriever of the prescription.

8. The method defined in claim 7, wherein the prescription is part of a prescription order that includes a plurality of prescriptions.

9. The method defined in claim 8, further comprising the step of collating the plurality of prescriptions prior to step (c).

10. The method defined in claim 7, further comprising the step of adjudicating the prescription.

11. The method defined in claim 7, wherein, if the inquiry in step (e) is negative, further comprising the step of manually verifying the prescription.

12. The method defined in claim 7, wherein the automated pharmaceutical dispensing system includes a plurality of bins, each containing a bulk supply of a pharmaceutical, and wherein the security feature comprises each of the bins including a security door, and wherein replenishment of one of the bins requires confirmation regarding the identity of a replenishing pharmaceutical in order to open the security door.

13. A method of verifying a prescription (Rx) dispensed by a pharmacy, comprising the steps of:
(a) entering host computer Rx identifying information about a prescription prescribing a pharmaceutical into a pharmacy host computer;
(b) dispensing the prescribed pharmaceutical into a container with an automated pharmaceutical dispensing machine, wherein the automated pharmaceutical dispensing machine includes a security feature that assures accurate replenishment of pharmaceuticals into the machine;
(c) scanning a label on the container to enter Rx identifying indicia for the prescription into an automated will call system;
(d) automatically correlating the Rx identifying indicia for the prescription to the host computer Rx identifying information for the prescription to verify that the pharmaceutical prescribed in the host computer Rx identifying information matches the pharmaceutical identified on the container label;
(e) responsive to a retrieval request, inquiring whether the prescription is verified via steps (b), (c) and (d); and
(f) providing the verified prescription to a retriever of the prescription.

14. The method defined in claim 13, wherein the prescription is part of a prescription order that includes a plurality of prescriptions.

15. The method defined in claim 14, further comprising the step of collating the plurality of prescriptions prior to step (c).

16. The method defined in claim 13, further comprising the step of adjudicating the prescription.

17. The method defined in claim 13, wherein, if the inquiry in step (e) is negative, further comprising the step of manually verifying the prescription.
